(19) United States
(12) Patent Application Publication
(10) Pub. No.: US 2025/0329059 A1
(43) Pub. Date: Oct. 23, 2025

(54) APPARATUS AND METHOD FOR IMAGE CONVERSION

(71) Applicant: SEOUL NATIONAL UNIVERSITY R&DB FOUNDATION, Seoul (KR)

(72) Inventors: Bo Hyung HAN, Seoul (KR); Jong Hyeon Seon, Seoul (KR); Jin Young Choi, Seoul (KR)

(21) Appl. No.: 19/256,888

(22) Filed: Jul. 1, 2025

Related U.S. Application Data
(63) Continuation of application No. PCT/KR2024/000029, filed on Jan. 2, 2024.

(30) Foreign Application Priority Data
Jan. 2, 2023 (KR) 10-2023-0000121

(51) Int. Cl. G06T 9/40

(52) U.S. Cl. CPC G06T 9/40

(57) ABSTRACT

An image conversion apparatus according to one embodiment includes: a memory that stores an image conversion program to compress a plurality of images into a single image or decompress the compressed single image into the plurality of images; and a processor that executes the image conversion program, and the image conversion program inputs the plurality of images into an encoder model and outputs the compressed single image in which the remaining images are inserted into one of the plurality of images, and the encoder model is machine-learned to compress a plurality of initially input images into a single image by hierarchically compressing the plurality of images into one according to a tree structure, ensuring the final compressed image is identical to one of the initially input images.

### CROSS-REFERENCE TO RELATED APPLICATION

This application is a continuation of International Application No. PCT/KR2024/000029 filed on Jan. 2, 2024, which claims the benefit under 35 USC 119(a) of Korean Patent Application No. 10-2023-0000121 filed on Jan. 2, 2023, in the Korean Intellectual Property Office, the entire disclosures of which are incorporated herein by reference for all purposes.

### TECHNICAL FIELD

The present disclosure relates to an apparatus and method for image conversion by compressing a plurality of images into a single image and decompressing the compressed single image into the plurality of images.

### BACKGROUND

Currently, video traffic is increasing by more than 30% annually, which leads to a growing demand for technologies that help understand and process large volumes of video more efficiently.

In order to efficiently store and rapidly transmit large volumes of video, video compression technologies are essential. Among these, video compression based on steganography has been developed, which involves inserting a plurality of images into a single image.

With this technology, when a plurality of images is input into an encoder, a single image including a plurality of inserted images can be generated. When this generated image is input into a decoder, the plurality of images inserted in the single image can be retrieved.

However, video compression based on steganography has limitations on the number of images that can be inserted into a single image. This implies limitations on the number of images that can be inserted while preserving the original image quality upon recovery. For example, if more than ten images are inserted into a single image, the quality of the recovered images significantly deteriorates. This poses a challenge to extending such a technology for compressing a video composed of a plurality of images.

Accordingly, there is a need for technologies that can overcome these limitations.

### DISCLOSURE OF THE INVENTION

### Problems to be Solved by the Invention

In view of the foregoing, the present disclosure is conceived to provide an apparatus and method for image conversion by compressing a plurality of images into a single image with an encoder model and decompressing the compressed single image into the plurality of images with a decoder model.

The problems to be solved by the present disclosure are not limited to the above-described problems. There may be other problems to be solved by the present disclosure.

### Means for Solving the Problems

As technical means for solving the above-described technical problems, an image conversion apparatus according to an embodiment of the present disclosure includes: a memory that stores an image conversion program to compress a plurality of images into a single image or decompress the compressed single image into the plurality of image; and a processor that executes the image conversion program, and the image conversion program inputs the plurality of images into an encoder model and outputs the compressed single image in which the remaining images are inserted into one of the plurality of images, and the encoder model is machine-learned to compress a plurality of initially input images into a single image by hierarchically compressing the plurality of images into one according to a tree structure, ensuring the final compressed image is identical to one of the initially input images.

Further, an image conversion method according to another embodiment of the present disclosure includes: a process of inputting a plurality of images into an encoder model; and a process of outputting a compressed single image in which the remaining images are inserted into one of the plurality of images, and the encoder model is machine-learned to compress a plurality of initially input images into a single image by hierarchically compressing the plurality of images into one according to a tree structure, ensuring the final compressed image is identical to one of the initially input images.

### Effects of the Invention

According to the present disclosure, it is possible to increase the number of images that can be compressed through an encoder model that hierarchically compresses a plurality of images into one according to a tree structure.

### BRIEF DESCRIPTION OF THE DRAWINGS

FIG. 1 is a configuration diagram of an image conversion apparatus according to an embodiment of the present disclosure.

FIG. 2 and FIG. 3 are diagrams illustrating a process of constructing an encoder model and a decoder model.

FIG. 4 to FIG. 6 illustrate application examples of the image conversion apparatus according to an embodiment of the present disclosure.

FIG. 7 is a flowchart illustrating an image conversion method according to an embodiment of the present disclosure.

### MODE FOR CARRYING OUT THE INVENTION

Hereafter, embodiments of the present disclosure will be described in detail with reference to the accompanying drawings. However, it is to be noted that the present disclosure is not limited to the embodiments but can be embodied in various other ways. Also, the accompanying drawings are provided to help easily understand the embodiments of the present disclosure and the technical conception described in the present disclosure is not limited by the accompanying drawings. In the drawings, parts irrelevant to the description are omitted for the simplicity of explanation, and the size, form and shape of each component illustrated in the drawings can be modified in various ways. Like reference numerals denote like parts through the whole document.

Suffixes “module” and “unit” used for components disclosed in the following description are merely intended for easy description of the specification, and the suffixes themselves do not give any special meaning or function. Further, in the following description of the present disclosure, a detailed explanation of known related technologies may be omitted to avoid unnecessarily obscuring the subject matter of the present disclosure.

Throughout the whole document, the term “connected to (contacted with or coupled to)” may be used to designate a connection or coupling of one element to another element and includes both an element being “directly connected to (contacted with or coupled to)” another element and an element being “indirectly connected to (contacted with or coupled to)” another element via another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Further, in describing components of the present disclosure, ordinal numbers such as first, second, etc. can be used only to differentiate the components from each other, but do not limit the sequence or relationship of the components. For example, a first component of the present disclosure may also be referred to as a second component and vice versa.

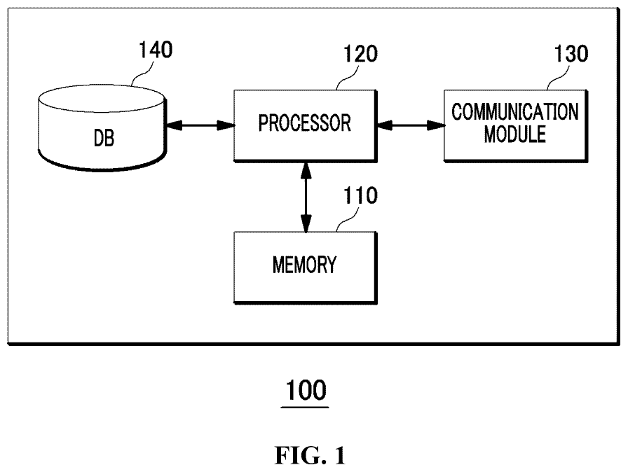

FIG. 1 is a block diagram schematically illustrating an image conversion apparatus according to an embodiment of the present disclosure.

An image conversion apparatus 100 according to an embodiment of the present disclosure will be described with reference to FIG. 1. The image conversion apparatus 100 is configured to compress a plurality of images into a single image or decompress the compressed single image into the plurality of images. To this end, the image conversion apparatus 100 includes a memory 110 and a processor 120.

The memory 110 stores an image conversion program. The memory 110 refers to a non-volatile storage device that continues to maintain stored information even when power is not supplied and a volatile storage device that requires power to maintain the stored information. The memory 110 may perform a function of temporarily or permanently storing data processed by the processor 120. Here, the memory 110 may include magnetic storage media or flash storage media in addition to the volatile storage device that requires power to maintain the stored information, but the scope of the present disclosure is limited thereto

The processor 120 executes the image conversion program stored in the memory 110 to input a plurality of images into an encoder model by and output a compressed single image in which the remaining images are inserted into one of the plurality of images. Then, the image conversion program inputs the image finally compressed in the encoder model into a decoder model to decode the final compressed image into a plurality of initial images. Herein, the image may be composed of a plurality of video frames or still images such as photographs of various shapes.

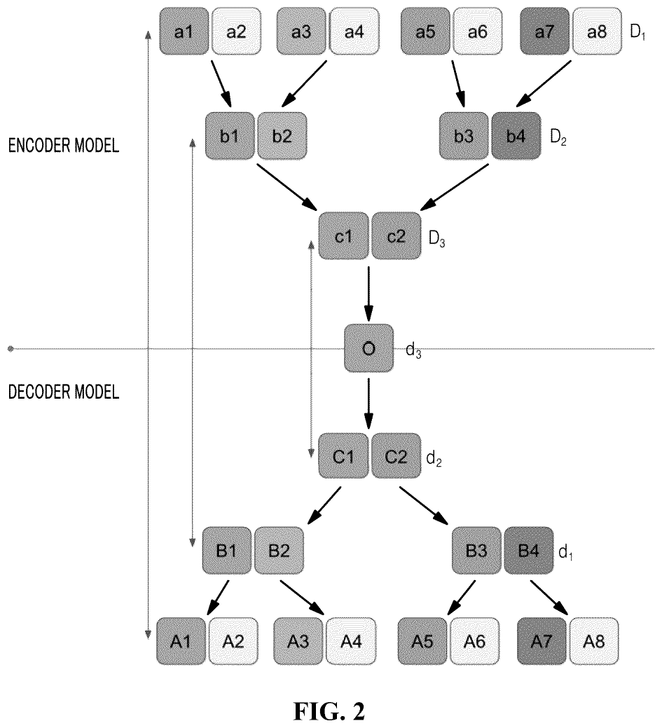

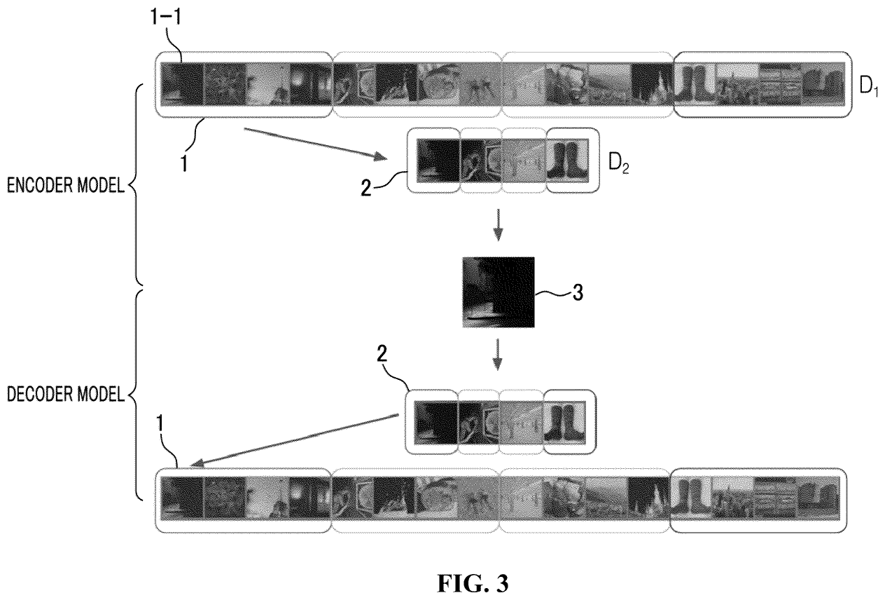

The encoder model used for compressing a plurality of images into a single image and the decoder model used for decompressing the compressed single image into the plurality of images will be described in detail with reference to FIG. 2 and FIG. 3.

The encoder model is machine-learned to compress a plurality of initially input images into a single image by hierarchically compressing the plurality of images into one according to a tree structure, ensuring the final compressed image is identical to one of the initially input images.

Hereinafter, a process of constructing the encoder model will be described. The encoder model is composed of D hierarchical layers and is machine-learned to split and compress a plurality of images into N images within each layer. The encoder model is machine-learned using a loss function to make the compressed image identical to one of the N uncompressed images.

Herein, when a plurality of images is input into each layer, compression information regarding the order of compression layers is also provided. The compression information includes information about the plurality of images input to each layer. The number of input layers D and the number of splits N are predetermined, which determines the number of initial images input into the encoder model. The number of initial input images is determined as N^{D}.

In the encoder model illustrated in FIG. 2, the number of layers D is set to three (3) and the number of splits N is set to two (2). Therefore, eight (8) initial images (2³=8) are input into the encoder model. For case of explanation, the compressed image is generated to be identical to the first image of the two images.

The operation of each layer is as follows. In a first layer D1, when eight images a1 to a8 and compression information of each image are input, they are sequentially split into pairs and compressed to generate four compressed images b1 to b4. Each compressed image is generated to be identical to the first of the two uncompressed images. For example, the image b1 is generated to be identical to the image a1.

In a second layer D2, when four images and compression information of each image are input, they are split into pairs and compressed to generate two compressed images. An image c1 generated by compressing the images b1 and b2 is identical to the image b1. The compression information input into the second layer D2 includes information about which images were compressed into each of the images b1 and b2. For example, the compression information includes information indicating that the images a1 and a2 were compressed into the image b1.

Then, in a third layer D3 which is the last layer, when two images and compression information of each image are input, a final compressed image O is generated by compressing the images c1 and c2. The final compressed image O includes all the images a1 to a8 and is identical to the image a1.

Hereinafter, the decoder model will be described. The decoder model is machine-learned to decompress the final compressed image into the plurality of initial images by hierarchically decompressing the single image into the plurality of images according to the reverse order of the tree structure. Herein, when a single image is input into each layer of the decoder model, decompression information regarding the order of decompression layers is also provided. The decompression information includes information about a plurality of images to be decompressed in each layer. For example, the decompression information includes information indicating that images A1 and A2 were compressed into an image B1.

Hereinafter, a process of constructing the decoder model will be described. The decoder model is trained simultaneously with the encoder model for the same layer. The decoder model proceeds in the reverse order of the encoder model's tree structure and is composed of the same number of layers (D). The decoder model is machine-learned to decompress a single image in each layer into N images. The decoder model is machine-learned using the same loss function as the encoder model to make the N decompressed images identical to the N uncompressed images.

The process of constructing the decoder model will be described in detail with reference to FIG. 2. Each layer of the decoder model is trained in the reverse order of the encoder model' training. In a first layer d1 of the decoder model, the images b1 to b4 generated by the first layer D1 of the encoder model are input as images B1 to B4, and images A1 to A8 are extracted from the images B1 to B4. The decoder model is trained using the same loss function as the encoder model to make the images A1 to A8 correspond to the images a1 to a8.

Thereafter, the images c1 and c2 generated by the second layer D2 of the encoder model are input as images C1 and C2 into a second model d2 of the decoder model, and the image B1 to B4 are extracted from the images C1 to C2. The decoder model is trained to make the images B1 to B4 correspond to the image b1 to b4.

Then, in a third layer d3 which is the last layer, when the final compressed image O is input, images C1 and C2 are extracted from the final compressed image O.

The operations of the encoder and decoder models constructed through the above process will be described with reference to FIG. 3.

The encoder model shown in FIG. 3 proceeds in a tree structure with two layers in which images are split into sets of four images and compressed. Sixteen initial images are input and split into four sets of four images by the first layer D1. Then, four images in each set are compressed into a single image. A compressed image 2 from a first set 1 is generated to be identical to a first image 1-1 of the first set 1.

The four compressed images generated by the first layer D1 are input into the second layer D2 and then compressed into a final image 3. This final compressed image 3 is generated to be identical to the first image 2 of the four input images. The final compressed image 3 becomes identical to the first image 1-1 in the first layer D1.

When the final compressed image 3 generated by the encoder model is input into the decoder model, the decoder model performs decompression according to the reverse order of the encoder model's tree structure and starts from the second layer d2. When the final compressed image 3 is input into the second layer d2, the four compressed images are extracted using a loss function. Then, the four images are input into the first layer d1, the four images compressed in each image are decompressed. Herein, the images compressed by the encoder model can be decompressed only by the decoder model which has been trained simultaneously with the encoder model.

In the present embodiment, the processor 120 may be implemented as a microprocessor, a central processing unit (CPU), a processor core, a multiprocessor, an application-specific integrated circuit (ASIC), or a field programmable gate array (FPGA), but the scope of the present disclosure is not limited thereto.

The communication module 130 enables data communication with an external device, and may include hardware and software required to transmit and receive a signal, such as a control signal or a data signal, through wired/wireless connection with other network devices.

The database 140 may store various data for operating the encoder model and the decoder model.

Meanwhile, the image conversion apparatus 100 according to an embodiment of the present disclosure may operate in the form of a server that receives a plurality of images for compression or a single compressed image from an external computing device, and compresses or decompresses images based on the received data. Further, the image conversion apparatus 100 may separately use the encoder model and the decoder model which have been trained simultaneously. Furthermore, the image conversion apparatus 100 of the present disclosure can be applied to any device equipped with a parallel processing computing unit.

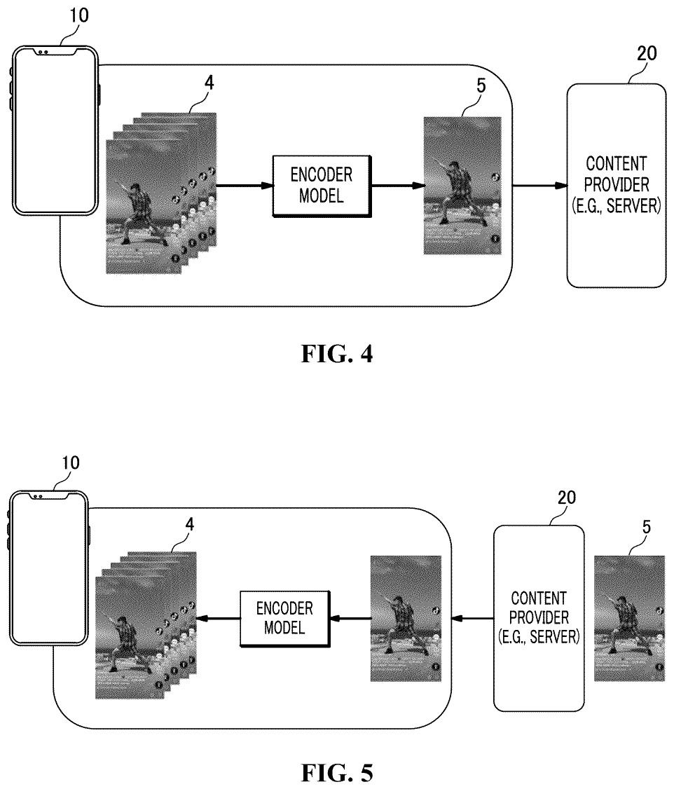

FIG. 4 to FIG. 6 illustrate application examples of the image conversion apparatus 100 according to the present disclosure.

Referring to FIG. 4, the image conversion apparatus 100 may be included in a user device 10, such as a smartphone, and may compress a plurality of frames of a video 4 recorded by the user device 10 into a single thumbnail 5. The thumbnail 5 can be transmitted to and stored in a content providing server 20.

As shown in FIG. 5, the user device 10 may receive the thumbnail 5 from the content providing server 20, decompress it using the decoder model, and play back the video 4.

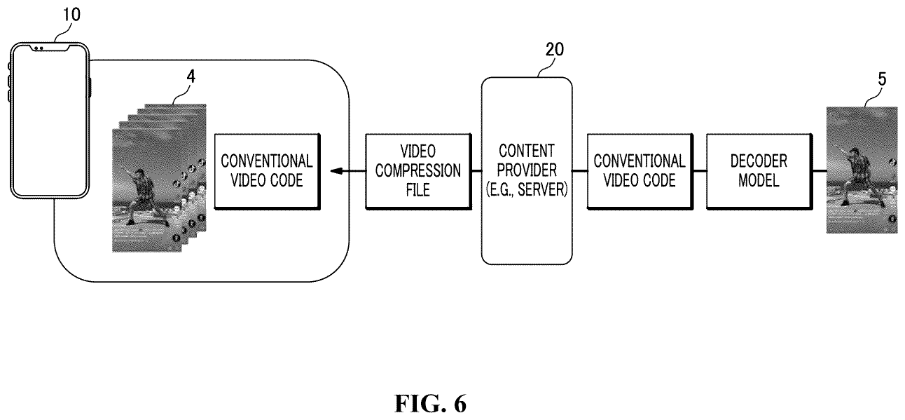

Further, as shown in FIG. 6, the content providing server 20 may be equipped with the image conversion apparatus 100 including only the decoder model. The stored thumbnail 5 is decompressed by the decoder model, compressed using a conventional video codec, and then transmitted to the user device 10.

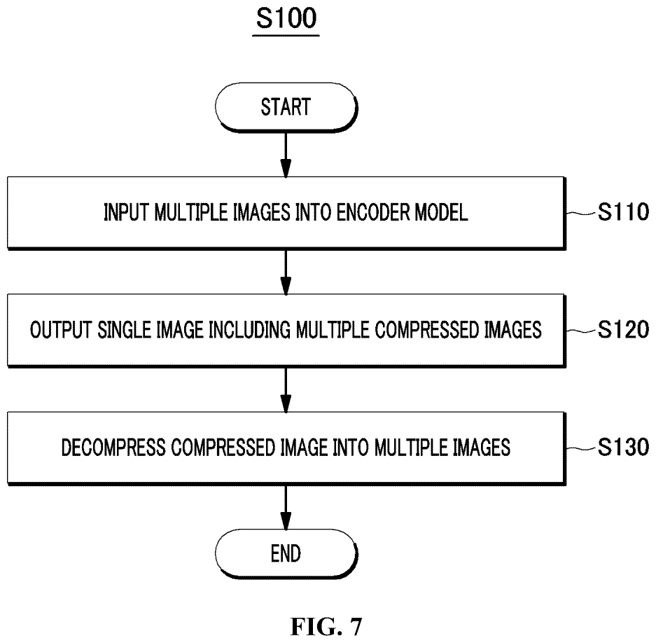

FIG. 7 is a flowchart illustrating an image conversion method according to an embodiment of the present disclosure.

Referring to FIG. 1 and FIG. 7, an image conversion method S100 according to the present embodiment includes: a process S110 of inputting a plurality of images into an encoder model; and a process S120 of outputting a compressed single image in which the remaining images are inserted into one of the plurality of images. Then, the final compressed image is input into a decoder model and decompressed into the plurality of images initially input into the encoder model (process S130).

Hereinafter, the encoder model and the decoder model will be described. The encoder model used in the process S110 is machine-learned to compress a plurality of initially input images into a single image by hierarchically compressing the plurality of images into one according to a tree structure, ensuring the final compressed image is identical to one of the initially input images. Herein, when a plurality of images is input into each layer, compression information regarding the order of compression layers is also provided. The compression information includes information about the plurality of images input to each layer.

The decoder model used in the process S130 is machine-learned to decompress the final compressed image into the plurality of initial images by hierarchically decompressing the single image into the plurality of images according to the reverse order of the tree structure. Herein, when a single image is input into each layer of the decoder model, decompression information regarding the order of decompression layers is also provided. The decompression information includes information about a plurality of images to be decompressed in each layer.

The decoder model is trained simultaneously with the encoder model for the same layer. The images compressed by the encoder model can be decompressed only by the decoder model which has been trained simultaneously with the encoder model. Further, the encoder model and the decoder model, which have been trained simultaneously, may be separated and used on different devices.

The present disclosure can be embodied in a storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage media. The computer storage media include all volatile/non-volatile and removable/non-removable media embodied by a certain method or technology for storing information such as computer-readable instruction code, a data structure, a program module or other data.

The method and system of the present disclosure have been explained in relation to a specific embodiment, but their components or a part or all of their operations can be embodied by using a computer system having general-purpose hardware architecture.

It would be understood by a person with ordinary skill in the art that various changes and modifications may be made based on the above description without changing technical conception and essential features of the present disclosure. Thus, it is clear that the above-described embodiments are illustrative in all aspects and do not limit the present disclosure. The scope of the present disclosure is defined by the following claims. It shall be understood that all modifications and embodiments conceived from the meaning and scope of the claims and their equivalents are included in the scope of the present disclosure.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. An image conversion apparatus, comprising:
a memory that stores an image conversion program to compress a plurality of images into a single image or decompress the compressed single image into the plurality of images; and
a processor that executes the image conversion program,
wherein the image conversion program inputs the plurality of images into an encoder model and outputs the compressed single image in which the remaining images are inserted into one of the plurality of images, and
the encoder model is machine-learned to compress a plurality of initially input images into a single image by hierarchically compressing the plurality of images into one according to a tree structure, ensuring the final compressed image is identical to one of the initially input images.

2. The image conversion apparatus of claim 1,
wherein the encoder model is machine-learned to split and compress a plurality of images into sets of N images within each of D hierarchical layers constituting the tree structure, and
the encoder model is machine-learned using a loss function to make the compressed image identical to one of the N images.

3. The image conversion apparatus of claim 1,
wherein the encoder model is machine-learned to split and compress a plurality of images into sets of N images within each of D hierarchical layers constituting the tree structure to make the compressed image identical to a first image of the N images.

4. The image conversion apparatus of claim 1,
wherein the encoder model is machine-learned to make the final compressed image, which was output from a final layer of the tree structure, identical to a first input image of the plurality of input images in a first layer.

5. The image conversion apparatus of claim 1,
wherein the image conversion program inputs the image finally compressed in the encoder model into a decoder model to decode the final compressed image into the plurality of initial images input into the encoder model, and
the decoder model is machine-learned to decompress the final compressed image, which was generated by the encoder model, into the plurality of initial images, which was input into the encoder model, by hierarchically decompressing the single image into the plurality of images according to the reverse order of the tree structure.

6. The image conversion apparatus of claim 5,
wherein the decoder model is machine-learned to make a first image of a plurality of decompressed images identical to an input image.

7. The image conversion apparatus of claim 5,
wherein the decoder model is machine-learned to make an input image, which was input into each of D hierarchical layers constituting the tree structure, identical to a first output image of a plurality of output images, which was decompressed by each layer, and
the decoder model is machine-learned to make a first output image of output images, which were output by a last layer of the tree structure, identical to an input image, which was input into the first layer.

8. The image conversion apparatus of claim 5,
wherein the encoder model and the decoder model are trained together based on the same training data, and
the encoder model and the decoder model are trained by performing inverse processes within the same layer.

9. The image conversion apparatus of claim 5,
wherein the encoder model is trained with compression information regarding the order of compression layers which is provided together when a plurality of input images is input, and
the decoder model is trained with decompression information regarding the order of decompression layers which is provided together when the input images are input.

10. The image conversion apparatus of claim 5,
wherein the encoder model is trained to make a first input image of the plurality of input images in a first layer identical to a compressed image output in response to an input image in a first layer, and
the decoder model is trained to perform decompression according to the same hierarchical structure as the encoder model when an image finally compressed by the encoder model is input, and to make a first output image decompressed in a final layer identical to the first input image.

11. An image conversion method, comprising:
inputting a plurality of images into an encoder model; and
outputting a compressed single image in which the remaining images are inserted into one of the plurality of images,
wherein the encoder model is machine-learned to compress a plurality of initially input images into a single image by hierarchically compressing the plurality of images into one according to a tree structure, ensuring the final compressed image is identical to one of the initially input images.

12. The image conversion method of claim 11,
wherein the encoder model is machine-learned to split and compress a plurality of images into N images within each of D hierarchical layers constituting the tree structure, and
the encoder model is machine-learned using a loss function to make the compressed image identical to one of the N images.

13. The image conversion method of claim 11,
wherein the encoder model is machine-learned to split and compress a plurality of images into sets of N images within each of D hierarchical layers constituting the tree structure to make the compressed image identical to a first image of the N images.

14. The image conversion method of claim 11,
wherein the encoder model is machine-learned to make the final compressed image, which was output from a final layer of the tree structure, identical to a first input image of the plurality of input images in a first layer.

15. The image conversion method of claim 11, further comprising:
a process of inputting the image finally compressed in the encoder model into a decoder model to decode the final compressed image into the plurality of initial images input into the encoder model,
wherein the decoder model is machine-learned to decompress the final compressed image, which was generated by the encoder model, into the plurality of initial images, which was input into the encoder model, by hierarchically decompressing the single image into the plurality of images according to the reverse order of the tree structure.

16. The image conversion method of claim 15,
wherein the decoder model is machine-learned to make a first image of a plurality of decompressed images identical to an input image.

17. The image conversion method of claim 15,
wherein the decoder model is machine-learned to make an input image, which was input into each of D hierarchical layers constituting the tree structure, identical to a first output image of a plurality of output images, which was decompressed by each layer, and
the decoder model is machine-learned to make a first output image of output images, which were output by a last layer of the tree structure, identical to an input image, which was input into the first layer.

18. The image conversion method of claim 15,
wherein the encoder model and the decoder model are trained together based on the same training data, and
the encoder model and the decoder model are trained by performing inverse processes within the same layer.

19. The image conversion method of claim 15,
wherein the encoder model is trained with information regarding the order of compression layers which is provided together when a plurality of input images is input, and
the decoder model is trained with information regarding the order of decompression layers which is provided together when the input images are input.

20. The image conversion method of claim 15,
wherein the encoder model is trained to make a first input image of the plurality of input images in a first layer identical to a compressed image output in response to an input image in a first layer, and
the decoder model is trained to perform decompression according to the same hierarchical structure as the encoder model when an image finally compressed by the encoder model is input, and to make a first output image decompressed in a final layer identical to the first input image.

21. A non-transitory computer-readable recording medium having recorded thereon a computer program for executing the image conversion method of claim 11.
